(19) United States
(12) Patent Application Publication
(10) Pub. No.: US 2016/0362600 A1
(43) Pub. Date: Dec. 15, 2016

(54) DISINTEGRATING UNIT DOSE POD FOR WELL SERVICING FLUIDS

(71) Applicant: Halliburton Energy Services, Inc., Houston, TX (US)

(72) Inventor: Ali Alwattari, The Woodlands, TX (US)

(73) Assignee: Halliburton Energy Services, Inc., Houston, TX (US)

(21) Appl. No.: 15/120,893

(22) PCT Filed: Apr. 1, 2014
(86) PCT No.: PCT/US14/32543

§ 371 Date: Aug. 23, 2016

(51) Int. Cl. C09K 8/70; E21B 43/267; C09K 8/88; C09K 8/42; C09K 8/68; E21B 43/26; C09K 8/03

(52) U.S. Cl. CPC C09K 8/70; E21B 43/26; E21B 43/267; C09K 8/03; C09K 8/42; C09K 8/685; C09K 8/706; C09K 8/887; C09K 2208/26; C09K 2208/24; C09K 2208/12

(57) ABSTRACT

Compositions and methods for formulating well servicing fluids at the well site are provided. The compositions and methods of the present disclosure may be applied to fracturing, drilling mud, cement, or water treatments and provide a higher degree of control over the sequence of permeation and events downhole in an oil or gas formation. In one embodiment, the method comprises: providing a pod comprising: at least one active ingredient, wherein the active ingredient comprises a constituent of an well servicing fluid; and at least one inactive ingredient encasing the active ingredient; allowing the pod to dissolve in an aqueous fluid to form a well servicing fluid; and introducing the well servicing fluid into a wellbore penetrating at least a portion of a subterranean formation.

### BACKGROUND

The present disclosure provides compositions and methods for formulating well servicing fluids at a well site.

Oilfield operations can involve drilling into a variety of subterranean formations. While porous subterranean formations allow hydrocarbons to flow freely to the well bore, other less permeable formations can inhibit the flow of hydrocarbons. These less permeable formations include, but are not limited to, shale plays and rocks that have one to several hundred (up to about 1000) millidarcies. A variety of techniques can be used to enhance the production from less permeable subterranean zones.

Hydraulic fracturing is one such process that is commonly used to increase the flow of desirable fluids from a portion of a subterranean formation. Traditional hydraulic fracturing operations usually comprise the steps of placing a viscous fracturing fluid (often an aqueous gelled fluid) into a portion of a subterranean formation at a rate and pressure such that fractures are created or enhanced in a portion of the subterranean formation. The fractures propagate, for example, as vertical and/or horizontal cracks radially outward from the well bore. The fracturing fluid may comprise particulates, often referred to as “proppant particulates,” that are deposited in the fractures. The proppant particulates function to prevent the fractures from fully closing upon the release of pressure, forming conductive channels through which fluids may flow to (or from) the well bore.

In many operations, fracturing fluids and other well servicing fluids are formulated at the well site. In some cases, certain constituents of the fracturing fluid exist in a dry form that is added to water at the well site. In other cases, a highly concentrated fluid containing the same chemical constituents can be added to water. These processes may require transportation and handling of hundreds of pounds of solid materials or concentrated fluid. As different solid materials may be sourced from different suppliers, coordinating their delivery at the well site and mixing the appropriate proportions on location may present significant challenges.

### BRIEF DESCRIPTION OF THE DRAWINGS

These drawings illustrate certain aspects of some of the embodiments of the present disclosure, and should not be used to limit or define the claims.

FIG. 1 illustrates an example of a system where certain embodiments of the present disclosure may be used.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF EMBODIMENTS

The present disclosure provides compositions and methods for formulating well servicing fluids at a well site in a more precise and compact product form. The compositions and methods of the present disclosure may be applied to fracturing, drilling mud, cement, or water treatments and provide a higher degree of control over the sequence of permeation and events downhole in an oil or gas formation.

Generally, the techniques of the present disclosure involve integrating the chemical constituents of servicing fluids in a dry and/or concentrated form and processing those chemicals into a pod, such as a tablet or a pouch, that may, among other benefits, promote ease of transportation and use. In certain embodiments, the pods may include disintegrants or solubility controls (e.g., thin film, thicker film, or no film at all) surrounding the pod; these may be used to facilitate and customize the solubility of the pod to formulate the servicing fluid onsite with high precision by adding the pods to an aqueous base fluid. The compositions and methods of the present disclosure may increase portability of the constituent chemicals for well servicing fluids, increase shelf-stability of constituent chemicals for well servicing fluids, and facilitate the onsite preparation of well servicing fluids. In certain embodiments, the compositions and methods can include separate compartments to co-deliver materials that might normally react or be incompatible when formulated into a single formulation as is done conventionally.

The compositions and methods of the present disclosure generally involve a disintegrating pod comprising at least one active ingredient. The active ingredients generally comprise the constituent chemicals used in a well servicing fluid, such as a fracturing fluid. Pods can also include active ingredients that may thicken and transform products such as drilling mud and casing cement since these are also fluid-solid mixtures wherein the slowing down or speeding up of structure formation and viscosification may be advantageously controllable with pods and compositions as described herein. In certain embodiments, the pods may also comprise an inactive ingredient and/or a disintegrant.

The pods can take a variety of shapes and sizes. Suitable shapes include, but not limited to, tetrahedroid, triangular, spheres, pillows, capsules, short rods or tubes, ravioli, cubes, box shapes, crescents, cones, stars, or alphabet letters (e.g., coded for the contents). In certain embodiments, and depending on the shape, the diameter or longest axis of the pod can range from about 100 microns to about 20 centimeters. A person of skill in the art, with the benefit of this disclosure, will be able to select an appropriate size and shape to facilitate the efficient manufacture, transportation, and use of the pods.

In certain embodiments, the pods of the present disclosure can take the form of either a tablet or a pouch having at least one compartment. In the tablet form, the active ingredients, the inactive ingredients, and/or the disintegrant may be compressed into the tablet. In the pouch form, the inactive ingredients may form the walls of the pouch. In certain embodiments, the outside wall of the pouch may have a thickness between about 500 μm to about 5000 μm. In embodiments where the pouch has internal walls, these internal walls may have a thickness between about 150 μm to about 2000 μm. The active ingredient and the disintegrant may be placed into the pouch. A person of skill in the art with the benefit of this disclosure would be able to select the appropriate form for a particular purpose.

The tablet form provides flexibility in creating different pods. In some embodiments, the active ingredients may be combined in a homogeneous mixture to disintegrate and dissolve at approximately the same rate. In other embodiments, the tablet may be created using separate layers of different active ingredients. This may permit the active ingredients to be released in a specific sequence as the tablet dissolves. In one example, sequential release may be used when the application requires the fast release of a gelling polymer and the slower erosional release of surfactant. In other example, a breaker may be released after a polymer and a surfactant. Tablets may be most appropriate when the active ingredients exist in a dry powder form that can be compressed.

The pouch form also provides flexibility. In some embodiments, the active ingredients may be combined in a single compartment. In other embodiments, the pouch may comprise multiple separate compartments that each contain a different active ingredient. This embodiment may prevent active ingredients from reacting with each other (or at least reduce such reactions) until the pod dissolves. Multiple incompatible chemicals may be transported together using this embodiment. Pouches also may be appropriate for both solid and liquid active ingredients.

The active ingredients may include any chemical that is used in a well servicing fluid. Examples of such well servicing fluids include, but are not limited to, fracturing fluids, well bore cements, a proppant slurry, drilling fluid or “mud,” acid treatment fluids, and fluid loss concentrates. Suitable active ingredients that may be used according to the teaching of the present disclosure include, but are not limited to, viscosifiers, friction reducers, pH control agents, surfactants, crosslinkers, clay stabilizers, breakers, pH agents, and inorganic ion crosslinkers. In certain embodiments, these constituent chemicals may be in a solid or dry form. In other embodiments, these constituent chemicals may be a concentrated liquid.

The polymer or surfactant particle size of the active ingredients may be chosen for the desired control and speed of dissolution. In certain embodiments, granules could be from 1 micron to 10 centimeters. In other embodiments, the granules may be from about 100 microns to about 5 millimeters. Smaller granules dissolve faster in general, and sizes can be blended to optimize manufacturing, loading, and unloading of pod contents, and the pods or tablets themselves. In the case of tablets, the binding and formation of the tablet may require particles of similar size range, among other reasons, to provide proper compaction during tablet making.

In certain embodiments, the active ingredients contained in the pod may be selected so that a desired well servicing fluid can be formulated simply by placing the pod in an aqueous base fluid and allowing it to dissolve. In certain embodiments, the dissolving process may be facilitated by optional processes, such as agitation or the addition of heat. Suitable aqueous base fluids may include, but are not limited to, fresh water, salt water, sea water, or brines. Similarly, the relative proportions of active ingredients in the pod may be adjusted to determine the final proportions of each active ingredient in the well servicing fluid. While in some embodiments, the individual pods may each contain multiple active ingredients, in other embodiments, separate pods having different active ingredients may be used for a single fluid. A person of skill in the art with the benefit of the teachings of this disclosure would know what active ingredients to include in a pod and in what proportions to correspond to a particular well servicing fluid.

The inactive ingredients may include any chemical that does not interfere with the active ingredient and maintains the structure of the pod during storage and transportation. The inactive ingredient maintains the structure of the pod by encasing the active ingredient to provide additional strength to the pod. The inactive ingredient may encase the active ingredient, for example, by surrounding the active ingredient in an outer layer or by being mixed with the active ingredient to form a mixture with appropriate mechanical properties to maintain the structure of the pod.

In embodiments where the pod is a tablet, the inactive ingredient may comprise a binder that is mixed with the active ingredient to encase it. Suitable binders include, but are not limited to, magnesium stearate, lactose monohydrate, sucrose, dextrin, microcrystalline cellulose, acacia, tragacanth, gelatin, starch paste, polyvinyl pyrrolidone, polyvinyl alcohol, hydroxypropyl cellulose, ethyl cellulose, polyethylene glycol, carboxymethyl cellulose, hydroxypropyl methyl cellulose, methyl cellulose, shellac, chitosan, chitosan lactate, polydimethyl siloxane, polyvinyl butyrate, polylactic acid, and combinations thereof. In some embodiments, the inactive ingredient may comprise a coating layer on the outside of the tablet that encases the active ingredient. The coating layer can be used in addition to or in place of a binder. Examples of suitable coating layers include, but are not limited to, polyvinyl alcohol, guar, carboxymethylcellulose, polyethylene oxide, starch octenyl succinate, hydroxyethyl cellulose, polyquaternium-10 (water soluble cationic cellulose based polymers), carboxymethyl hydroxyethyl cellulose, polyethylene glycol, polyvinyl pyrrolidone, hydroxypropyl cellulose, polyvinylpyrrolidone-vinyl acetate (PVP/VA) copolymer and combinations thereof.

In embodiments where the pod is a pouch, the inactive ingredient may comprise the material for the outside wall of the pouch and/or the internal walls of the pouch that act as dividers or compartments encase the active ingredient and/or to separate chemically different ingredients from each other until the point of use of the pod. Suitable materials for the wall of the pouch include, but are not limited to, high temperature water-soluble plastics such as polyethylene oxide or polyvinyl alcohol, guar, carboxymethylcellulose, polyethylene oxide, starch octenyl succinate, hydroxyethyl cellulose, polyquaternium-10 (water soluble cationic cellulose based polymers), carboxymethyl hydroxyethyl cellulose, polyethylene glycol, polyvinyl pyrrolidone, hydroxypropyl cellulose, polyvinylpyrrolidone-vinyl acetate (PVP/VA) copolymer, and combinations thereof.

The disintegrants may include chemicals that facilitate the break-down and dissolution of the pods in the aqueous solution. The disintegrants may act in a variety of mechanisms or a combination of mechanisms. For example, in certain embodiments, the disintegrant may include chemicals that swell upon contact with water and break apart the pod. In other embodiments, the disintegrant may include chemicals that dissolve more rapidly than surrounding components thereby facilitating water influx and/or efflux by forming channels in the pod. In other embodiments, the disintegrant may produce a gas that breaks apart the pod. In some embodiments, the disintegrant is optional and may not be used including, for example, where a delayed release is desired.

Any known disintegrating agent that does not interfere with the active agent may be suitable. This includes but is not limited to starch, starch derivatives (for example PRIMELLOSE® and/or PRIMOGEL® available from Auebe, AVICEL® available from FMC), alginic acid or salts thereof (available from Kelco), carboxymethylcellulose (CMC), CMC-based polymers (for example NYMCEL® available from Metsa-Serla, EXPLOTAB® available from Mendell, AC-DI-SOL® available from FMC), polyvinyl pyrrolidone (PVP), cross-linked PVP, sodium acetate, potassium carbonate, potassium sulfate, Glaubers salts, sugars (especially mannitol and sorbitol), aluminum oxide, crosslinked hydroxyethyl cellulose, sodium polyacrylate and mixtures thereof. Other suitable disintegrating agents include hydrogels such as polyacrylic acid, polyacrylamide copolymer, ethylene maleic anhydride copolymer, cross-linked carboxymethylcellusose, polyvinyl alcohol copolymers, cross-linked polyethylene oxide, and starch grafted copolymer of polyacrylonitrile (all of which behave as superabsorbent materials and can enlarge, expand, and disintegrate surrounding matrix such as compacted particles by absorbing water quickly and in very high amount). Examples of categories of suitable disintegrants are shown in Table 1 and described in more detail below.

TABLE 1
Disintegrants

| Categories of | | |
|---|---|---|
| Disintegrant | Examples | Mechanism of Action |
| Cross-linked | Crosscarmellose ® | Swells 4-8 fold in under |
| cellulose | Ac-Di-Sol ® | 10 seconds. |
| | Primellose ® | Also draws fluid into the |
| | Vivasol ® | polymer. |
| Cross-linked PVP | Crosspovidone | Swells 7-12 fold in under |
| | Kollidon | 30 seconds. |
| | Polyplasdone | Swells very little and |
| | | returns to original size |
| | | after compression but acts |
| | | by capillary action. |
| Cross-linked starch | Sodium Starch | Swells 7-12 fold in under |
| | Glycolate | 30 seconds. |
| Cross-linked alginic | Alginic acid NF | Rapid dissolving. |
| acid | Emcosoy | |
| Calcium Silicate | Calcium Silicate | Draws fluid into the polymer. |

Cross-linked Cellulose and Their Derivatives: Cross-linked sodium carboxymethylcellulose is a white, free-flowing powder with a high absorption capacity. It has a high swelling capacity and thus provides rapid disintegration and drug dissolution at lower levels. It also has an outstanding water wicking capability and its cross-linked chemical structure creates an insoluble hydrophilic, highly absorbent material resulting in excellent swelling properties. It is insoluble in water and swells rapidly. The grades LH-11 and LH-21 exhibit the greatest degree of swelling. In certain embodiments, the pods may have a concentration of sodium carboxymethylcellulose between about 0.5-5%. In preferred embodiments, the concentration is between about 0.5-2%.

Cross-linked polyvinylpyrrolidone (Crosslinked PVP): Cross-linked PVP is a completely water insoluble polymer. It rapidly disperses and swells in water but does not gel even after prolonged exposure. It acts by wicking, swelling and possibly some deformation recovery. The rate of swelling is among the highest of the disintegrants identified in this disclosure. The polymer has a small particle size distribution that dissolves quickly. Varieties of grades are available commercially as per their particle size in order to achieve a uniform dispersion for direct compression with the formulation. In certain embodiments, the pods may have a concentration of cross-linked PVP between about 1-3%.

Modified starches/Crosslinked starch: Sodium starch glycolate is the sodium salt of a carboxymethyl ether of starch. It can take up more than 20 times its weight in water. The resulting high swelling capacity combined with rapid uptake of water accounts for a high disintegration rate and efficiency. It is available in various grades which differ in pH, viscosity and sodium content. Other special grades are available which are prepared with different solvents and thus the product has a low moisture (<2%) and solvent content (<1%). In certain embodiments, the pods have a concentration of sodium starch glycolate between about 2-8%.

Cross-linked Alginic Acid: It is insoluble in water and disintegrates by swelling or wicking action. It is a hydrophilic colloidal substance, which has high absorption capacity. It is also available as salts of sodium and potassium. In certain embodiments, the pods may have a concentration of sodium starch glycolate between about 0.1-10%. In preferred embodiments, the pods may have a concentration of sodium starch glycolate between about 1-3%.

Calcium Silicate: It is a highly porous, lightweight disintegrant, which acts by wicking action. In certain embodiments, the pods may have a concentration of salcium silicate between about 20-40%.

Others: Gellan gum is an anionic polysaccharide of linear tetrasaccharides, derived from Pseudomonas elodea having good disintegrant properties similar to the modified starch and celluloses. Xanthan Gum derived from Xanthomonas campestris is official in USP with high hydrophilicity and low gelling tendency. It has low water solubility and extensive swelling properties for faster disintegration. Ion exchange resins, such as INDION 414 has been used as a super-disintegrant. It is chemically cross-linked polyacrylic, with a functional group of —COO— and the standard ionic form is K+. It has a high water uptake capacity.

The methods and compositions of the present disclosure may be used in a variety of ways. In one example, pods containing the constituent chemicals of a well service fluid may be used to enable the “just add water” preparation of the well service fluid. In this example, the pods are added to water at the surface of the well site and allowed to dissolve before the resulting fluid is introduced into the wellbore. This can simplify the preparation of the well service fluid on site by reducing the operational footprint of the mixing process, streamlining the logistics by eliminating the need to transport different materials to the location, and reducing the level of training necessary for personnel who prepare the well service fluid. In another example, the pods of the present disclosure may be used to tailor well treatments on-the-fly by introducing the pods directly into the wellbore. In this example, the pods are allowed to dissolve in situ in the wellbore or the subterranean formation. The pods may be added to the fluid circulated in the wellbore at a specific location or specific time.

In one embodiment, a pod may be prepared by combining carboxymethylcellulose, calcium carbonate, mannitol, and a distintegrant. The carboxymethylcellulose is the active ingredient and may be present in a range of about 0.01-40% by mass. The carboxymethylcellulose forms a gel that is used to create fracturing fluids when it is crosslinked by a crosslinker. Calcium carbonate is another active ingredient and may be present in a range of about 0.01-45% by mass. The calcium carbonate would disintegrate while releasing carbon dioxide either upon reaction with an acid or upon reaching a high temperature for example when fluid hits the bottom of an oil well hole. Mannitol is an inactive ingredient and may be present in a range of about 10-70% by mass. Mannitol is sticky and may hold the pod together when it is dry. However, when the pod is added to water, the mannitol may act like a chemical sponge and absorb water into the pod which causes the pod to break apart. The disintegrant may comprise a PVP disintegrant and/or a gas producing additive (e.g., citric acid) and may be present in a range of about 0.001-99% by mass. PVP disintegrant creates a large amount of force to break apart the pod by absorbing water until it explodes. The proportions of each ingredient may be adjusted within the range. For example, including a higher proportion of mannitol may result in a lower concentration of the active ingredients, but it may bring in water faster to break apart the pod more quickly. A higher proportion of mannitol also may make the pod more stable during storage and transportation.

In another embodiment, a pod may be prepared by combining the constituents in a 100 gram pod or tablet (defined as 100 wt % basis for the composition). In the case where all ingredients are used in solid or most concentrated versions, the pod composition may include 47.5% gellant polymer (e.g. carboxymethylcellulose or guar), 25.6% friction reducer (e.g. polyacrylamide), 12.656% biocide 7.97% crosslinker (e.g. borate, zirconate, titanate), 6.25% scale inhibitor, and 0.024% breaker (oxidative and/or enzymatic).

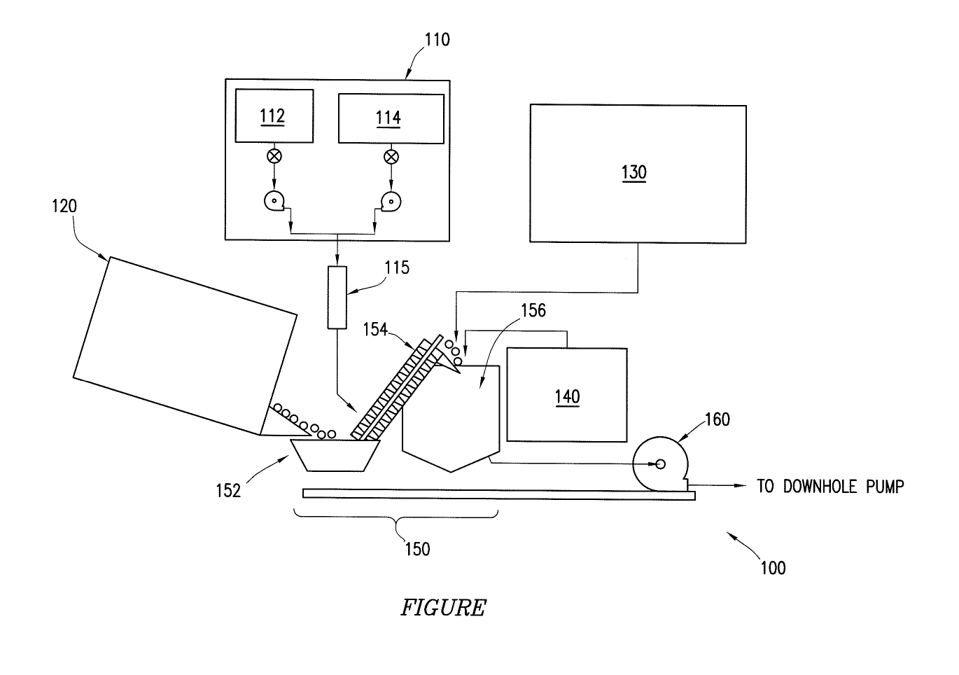

The exemplary chemicals disclosed herein may directly or indirectly affect one or more components or pieces of equipment associated with the preparation, delivery, recapture, recycling, reuse, and/or disposal of the disclosed chemicals. For example, and with reference to FIG. 1, the disclosed chemicals may directly or indirectly affect one or more components or pieces of equipment associated with an exemplary mixing assembly 100, according to one or more embodiments. As one skilled in the art would recognize, the mixing assembly 100 may be used with land-based or sea-based operations.

The mixing assembly 100 may be used to perform a process such as an on-the-fly resin coating process during a hydraulic fracturing treatment. As illustrated, the mixing assembly 100 may include a liquid resin skid 110, a sand transport 120, a liquid gel 130, a fracturing additive 140, a fracturing blender 150 and a booster pump 160. In particular, resin from the liquid resin skid 110, sand or other proppant particulates from the sand transport 120, the liquid gel 130, and the fracturing additive 140 are combined in the fracturing blender 150 to form a proppant slurry. The booster pump 160 pumps the slurry to the wellbore where it is pumped downhole with high pressure pump(s).

The liquid resin skid 110 may include a liquid resin 112 and a hardener 114. Types of suitable resins include, but are not limited to, two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof. The liquid resin 112 and hardener 114 are combined by the static mixer 115 to form a homogeneous mixture before they are introduced into the fracturing blender 150.

The fracturing blender 150 may include a sand hopper 152, a sand screw 154, and a blender tub 156. Sand or other proppant particulates may be transferred from the sand transport 120 to the sand hopper 152. From there, the sand screw 154 may transfer the sand or other proppant particulates to the blender tub 156. In the blender tub 156, the sand or other proppant particulates may be mixed with the resin and other components to form a resin-coated particulate slurry that is ready to be pumped downhole.

As discussed earlier, the pods according to the present disclosure may be used to simplify the on-site preparation of a fracturing fluid. In one embodiment, they may be added directly to the fracturing blender 150 (with water) in lieu of the separate liquid gel 130 and fracturing additive 140. This eliminates steps as well as separate components from the process. After mixing, the fracturing fluid may be pumped into the wellbore using a variety of pumps including, for example, positive displacement pumps.

To facilitate a better understanding of the present disclosure, the following examples of certain aspects of some embodiments are given. In no way should the following examples be read to limit or define the scope of the claims.

### EXAMPLES

### Example 1

The following experiment was conducted to test the ability of dried constituent chemicals to be reconstituted in water. Carboxymethylcellulose was used as a representative polymer. Zirconium lactate was used as a representative cross-linker. In this experiment, 0.03 grams of freeze dried zirconium lactate were added to 0.3 grams Carboxymethylcellulose powder, and the mixture was placed into a jar containing 10 mL of deionized water. The jar was placed in a 50° C. water bath, and within an hour, a viscous gel had formed. This experiment demonstrates that the dry form of the active ingredients can be reconstituted in a solution state, which shows that active ingredients may be successfully transported using the pods of the present disclosure and still reconstituted for use at the well site.

An embodiment of the present disclosure is a method comprising: providing a pod comprising: at least one active ingredient, wherein the active ingredient comprises a constituent of an well servicing fluid; and at least one inactive ingredient encasing the active ingredient; allowing the pod to dissolve in an aqueous fluid to form a well servicing fluid; and introducing the well servicing fluid into a wellbore penetrating at least a portion of a subterranean formation. Optionally, the well servicing fluid is a fracturing fluid. Optionally, the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof. Optionally, the pod further comprises at least one disintegrant. Optionally, the disintegrant comprises a compound selected from the group consisting of: a cross-linked cellulose, a cross-linked PVP, a cross-linked starch, a cross-linked alginic acid, calcium silicate, and any combination thereof. Optionally, the pod is a pouch having at least one compartment. Optionally, the pod is dissolved in the aqueous fluid in a blender tub.

Another embodiment of the present disclosure is a method comprising: providing a pod comprising: at least one active ingredient, wherein the active ingredient comprises a constituent of a well servicing fluid; and at least one inactive ingredient encasing the active ingredient; introducing the pod into a wellbore penetrating at least a portion of a subterranean formation; and allowing the pod to dissolve in an aqueous fluid in the portion of the subterranean formation. Optionally, the well servicing fluid is a fracturing fluid. Optionally, the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof. Optionally, the pod further comprises at least one disintegrant. Optionally, the disintegrant comprises a compound selected from the group consisting of: a cross-linked cellulose, a cross-linked PVP, a cross-linked starch, a cross-linked alginic acid, calcium silicate, and any combination thereof. Optionally, the pod is a pouch having at least one compartment. Optionally, the pod is introduced into the wellbore by placing the pod in a circulated fluid.

Another embodiment of the present disclosure is a pod composition comprising: at least one active ingredient, wherein the active ingredient comprises a constituent of a well servicing fluid; and at least one inactive ingredient encasing the active ingredient. Optionally, the well serving fluid is a fracturing fluid. Optionally, the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof. Optionally, the pod composition further comprises at least one disintegrant. Optionally, the disintegrant comprises a compound selected from the group consisting of: a cross-linked cellulose, a cross-linked PVP, a cross-linked starch, a cross-linked alginic acid, calcium silicate, and any combination thereof. Optionally, the pod is a pouch having at least one compartment.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a pod comprising:
at least one active ingredient, wherein the active ingredient comprises a constituent of an well servicing fluid; and
at least one inactive ingredient encasing the active ingredient;
allowing the pod to dissolve in an aqueous fluid to form a well servicing fluid; and
introducing the well servicing fluid into a wellbore penetrating at least a portion of a subterranean formation.

2. The method of claim 1 wherein the well servicing fluid is a fracturing fluid.

3. The method of claim 1 wherein the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof.

4. The method of claim 1 wherein the pod further comprises at least one disintegrant.

5. The method of claim 4 wherein the disintegrant comprises a compound selected from the group consisting of: a cross-linked cellulose, a cross-linked PVP, a cross-linked starch, a cross-linked alginic acid, calcium silicate, and any combination thereof.

6. The method of claim 1 wherein the pod is a pouch having at least one compartment.

7. The method of claim 1 wherein the pod is dissolved in the aqueous fluid in a blender tub.

8. A method comprising:
providing a pod comprising:
at least one active ingredient, wherein the active ingredient comprises a constituent of a well servicing fluid; and
at least one inactive ingredient encasing the active ingredient;
introducing the pod into a wellbore penetrating at least a portion of a subterranean formation; and
allowing the pod to dissolve in an aqueous fluid in the portion of the subterranean formation.

9. The method of claim 8 wherein the well servicing fluid is a fracturing fluid.

10. The method of claim 8 wherein the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof.

11. The method of claim 8 wherein the pod further comprises at least one disintegrant.

12. The method of claim 11 wherein the disintegrant comprises a compound selected from the group consisting of: a cross-linked cellulose, a cross-linked PVP, a cross-linked starch, a cross-linked alginic acid, calcium silicate, and any combination thereof.

13. The method of claim 8 wherein the pod is a pouch having at least one compartment.

14. The method of claim 8 wherein the pod is introduced into the wellbore by placing the pod in a circulated fluid.

15. A pod composition comprising:
at least one active ingredient, wherein the active ingredient comprises a constituent of a well servicing fluid; and
at least one inactive ingredient encasing the active ingredient.

16. The pod composition of claim 15 wherein the well serving fluid is a fracturing fluid.

17. The pod composition of claim 15 wherein the active ingredient comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof.

18. The pod composition of claim 15 further comprising at least one disintegrant.

19. The pod composition of claim 18 wherein the disintegrant comprises a compound selected from the group consisting of: a cross-linked cellulose, a cross-linked PVP, a cross-linked starch, a cross-linked alginic acid, calcium silicate, and any combination thereof.

20. The pod composition of claim 15 wherein the pod is a pouch having at least one compartment.
